(19) United States
(12) Patent Application Publication
(10) Pub. No.: US 2004/0242446 A1
(43) Pub. Date: Dec. 2, 2004

(54) Cleaning agent including a corrosion inhibitor used in a process of forming a semiconductor device

(75) Inventors: Chang-Sup Mun, Suwon-si (KR); Sang-Jun Choi, Seoul (KR); Woo-Sung Han, Seoul (KR); Chang-Ki Hong, Seongnam-si (KR)

Correspondence Address: F. CHAU & ASSOCIATES, LLC, 130 WOODBURY ROAD, WOODBURY, NY, 11797, US

(73) Assignee: SAMSUNG ELECTRONICS CO., LTD.

(21) Appl. No.: 10/774,783

(22) Filed: Feb. 9, 2004

(30) Foreign Application Priority Data
Jun. 2, 2003 (KR) 2003-35345

(51) Int. Cl. C11D 1/00

(52) U.S. Cl. 510/175

(57) ABSTRACT

A cleaning solution having a corrosion inhibitor and a surfactant is disclosed. The corrosion inhibitor is represented by formula 1 and the surfactant is represented by the formula 2 as follows:

R₁—R₂—C≡C—R₃—R₄ <Formula 1>

R₅—(CH₂)_{K}-A <Formula 2>

In formula 1, any one of R₁ and R₄ is a hydroxyl group (—OH) and the other is hydrogen (—H), a halogen element (—X) or one functional group selected from the group consisting of alkyl (—R) group, alkoxy (RO—) group, amino (—NH₂) group, nitro (—NO₂) group, mercapto (—SH) group, hydroxyl (—OH) group, aldehyde (—CHO) group and carboxyl (—COOH) group. R₂ and R₃ are hydrocarbons having 0 to 10 carbons including a straight or a branched structure. In formula 2, R₅ is methyl group and K is an integer ranging from 3 to 22. A is HO(CH₂CH₂O)_{L}(CH(CH₃)CH₂O)M or hydroxyl group, and L and M are integers ranging from 0 to 15.

### FIELD OF THE INVENTION

The present invention relates to a cleaning solution used in a process of fabricating a semiconductor device, and more particularly to a cleaning solution including a corrosion inhibitor.

### BACKGROUND

In semiconductor devices, metals, e.g., aluminum, copper or tungsten, are frequently used as an interconnect or a contact plug. As semiconductor devices become more highly integrated, a gate electrode is formed of a metal for reducing resistance of the gate electrode. Generally, to form a gate electrode or an interconnect, a metal layer is deposited and patterned. Then, a cleaning process is performed for removing byproducts, e.g., a polymer that may be deposited on a semiconductor device after a patterning process. In addition, a cleaning process usually employs a conventional cleaning solution such as a standard cleaning 1 (SC1) or a sulfuric peroxide mixture (SPM). The SC1 is a mixture of ammonia-water (NH₄OH), hydrogen peroxide (H₂O₂) and deionized water (H₂O), and SPM is a mixture of sulfuric acid (H₂SO₄) and hydrogen peroxide (H₂O₂). However, the strong oxidizing agent, such as the hydrogen peroxide, severely corrodes metals, such as tungsten, during the cleaning process.

Typically, a corrosion inhibitor is used for preventing the corrosion of a metal. Conventional corrosion inhibitors employ aromatic hydrocarbons such as benzotriazole and 5-methylbenzoimidazole. However, aromatic hydrocarbons cause environmental problems and are harmful to human health. The U.S. Pat. No. 6,200,947 discloses a conventional corrosion inhibitor, such as 2-mercaptoethanol and thioglycerol, which are aromatic alcohols having a mercapto group. These materials are environmentally sound. However, the corrosion inhibitors of aromatic alcohols having a mercapto group severely etch polysilicon to form an undercut region at a polysilicon pattern or a pit at a silicon substrate.

Therefore, there is a need for an environmentally sound cleaning solution having a corrosion inhibitor that effectively cleans a semiconductor device while preventing the corrosion metals or etching of polysilicon on the semiconductor device.

### SUMMARY OF THE INVENTION

Exemplary embodiments of the present invention provide an environmentally sound cleaning solution capable of preventing corrosion of metals and significantly reducing the etching of polysilicon of a semiconductor device.

Embodiments of the invention are directed to a cleaning solution having a corrosion inhibitor having a triple bond and at least one hydroxyl group (—OH).

The corrosion inhibitor is represented by formula 1 as follows:

R₁—R₂—C═C—R₃—R₄ <Formula 1>

In formula 1, any one of R₁ and R₄ is a hydroxyl group (—OH) and the other is hydrogen (—H), a halogen element (—X), or a functional group selected from the group consisting of alkyl (—R) group, alkoxy (RO—) group, amino (—NH₂) group, nitro (—NO₂) group, mercapto (—SH) group, hydroxyl (—OH) group, aldehyde (—CHO) group and carboxyl (—COOH) group. R₂ and R₃ are hydrocarbons having 0 to 10 carbons, which can be either a straight or a branched structure.

In addition, the other R₁ or R₄ may be a hydroxyl group (—OH), methyl group (—CH₃), or methoxy group (—OCH₃).

In another exemplary embodiment of the invention, a corrosion inhibitor represented by formula 1 may be included in a cleaning solution in the range of about 0.0001 to about 10 wt. % of the cleaning solution. Preferably, the corrosion inhibitor is about 0.001 to about 1 wt. % of a cleaning solution.

In yet another exemplary embodiment of the invention, if R₁ and R₄ are a hydroxyl group and R₂ and R₃ are —CH₂— of the corrosion inhibitor represented by formula 1, then the corrosion inhibitor is a 2-Butyne-1,4-diol.

A corrosion inhibitor represented by formula 1 has a linear structure that naturally decomposes and is environmentally sound. In addition, the triple bond of the corrosion inhibitor can prevent corrosion of metals. The prevention of corroding metals may be because a metal does not lose electrons due to the presence of electrons existing in the triple bond. The corrosion inhibitor may be readily dissolved in water due to a hydroxyl group contained therein. Also, the corrosion inhibitor may function as a surfactant at an interface between a metal and the cleaning solution or between polysilicon and the cleaning solution due to the hydroxyl group contained therein. The corrosion inhibitor may reduce damage to the polysilicon by being absorbed at a surface of the polysilicon, thereby protecting the surface of the polysilicon. Further, R₁ and R₄ may be controlled to increase the solubility in water and surface-active ability of a corrosion inhibitor represented by formula 1 at the interface between a cleaning solution including a corrosion inhibitor represented by formula 1 and the polysilicon.

In still another exemplary embodiment of the invention, a cleaning solution may further include a surfactant represented by formula 2 as follows:

R₅—(CH₂)_{K}-A <Formula 2>

In formula 2, R₅ is methyl group and K is an integer ranging from 3 to 22, and A is HO(CH₂CH₂O)_{L}(CH(CH₃)CH₂O)_{M}— or hydroxyl group. In addition, L and M are integers ranging from 0 to 15. The surfactant may be included in a cleaning solution in a range of about 0.0001 to about 10 wt. % of the cleaning solution. Preferably, the surfactant may be about 0.001 to about 1 wt. % of a cleaning solution.

In another exemplary embodiment, C₁₂H₂₅O(CH₂CH₂O)_{J}H may be a representative of a surfactant of formula 2, wherein J is an integer ranging from 5 to 15. C₁₂H₂₅O(CH₂CH₂O)ⱼH may be obtained when R5 is methyl group, K is 11, L is equal to J, and M is zero in formula 2.

In yet another exemplary embodiment of the invention, CH₃(CH₂)₁₁(CH₂CH₂O)_{L}(CH(CH₃)CH₂O)_{M}OH or CH₃(CH₂)₁₇(CH₂CH₂O)_{L}(CH(CH₃)CH₂O)_{M}OH may be another representative of a surfactant of formula 2. Further, CH₃(CH₂)₁₁(CH₂CH₂O)_{L}(CH(CH₃)CH₂O)_{M}OH is an adduct of propylene oxide and ethylene oxide of a lauryl alcohol, and CH₃(CH₂)₁₇(CH₂CH₂O)_{L}(CH(CH₃)CH₂O)_{M}OH is an adduct of propylene oxide and ethylene oxide of a stearyl alcohol.

Further, a surfactant may be synthesized by being extracted from a coconut or a palm tree. In addition, the surfactant has a linear structure that naturally decomposes and is environmentally sound. The surfactant also reduces damage to polysilicon by being deposited on a surface of the polysilicon. In other words, the surfactant is absorbed at the surface of polysilicon, thereby protecting the polysilicon. Further, the surfactant may function as cleaning particles on the polysilicon or on metals. The ratio of K, L and M of a surfactant represented by formula 2 may be changed to control the solubility in water and surface-active ability of a surfactant represented by formula 2 at the interface between the polysilicon and the cleaning solution including a surfactant represented by formula 2.

In still another exemplary embodiment of the invention, the cleaning solution may further include an acid solution or an alkaline solution. The alkaline solution may be selected from the group consisting of sodium hydroxide (NaOH), potassium hydroxide (KOH), ammonium hydroxide (NH₄OH), tetramethyl ammonium hydroxide (N(CH₃)₄OH) and chloride solution. The alkaline solution may be included in the range of about 0.0001 to about 10 wt. % of a cleaning solution. Preferably, the alkaline solution is about 0.01 to about 5 wt. % of a cleaning solution. Preferably, a cleaning solution including the alkaline solution is used after a copper damascene process or a planarization process such as a chemically mechanically polishing (CMP).

The acid solution may be selected from the group consisting of hydrochloric acid (HCl), nitric acid (HNO₃), sulfuric acid (H₂SO₄), phosphoric acid (mP₂O₅.nH₂O), fluoric acid (HF) and an organic acid. The organic acid may be selected from the group consisting of citric acid, tricarballylic acid, tartaric acid, succinic acid, malic acid, aspartic acid, glutaric acid, adipic acid, suberic acid, oxalic acid, acetic acid and fumaric acid. The acid solution may be included in a range of about 0.0001 to about 10 wt. % of a cleaning solution. Preferably, the acid solution is about 0.01 to about 5 wt. % of a cleaning solution.

### DESCRIPTION OF EXEMPLARY EMBODIMENTS

The present invention will now be described more fully hereinafter. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art.

<Experiment 1: Testing a Cleaning Solution Including a Corrosion Inhibitor Represented by Formula 1>

Experiment 1 was performed under conditions of table 1 to investigate the effects of a corrosion inhibitor represented by formula 1. In experiment 1, three cleaning solutions were prepared. Cleaning solution 1 was prepared with 200 ml of deionized water and 20 ml of 3% ammonia solution but without any corrosion inhibitor. Cleaning solution 2 was prepared with 200 ml of deionized water, 20 ml of 3% ammonia solution and 0.2 g of 2-mercaptoethanol, which is a conventional corrosion inhibitor. Cleaning solution 3 was prepared with 200 ml of deionized water, 20 ml of 3% ammonia solution and 0.2 g of 2-butyne 1,4-diol, which is a corrosion inhibitor according to an exemplary embodiment of the present invention.

After preparing three cleaning solutions, three wafers blanketed with tungsten and three wafers blanketed with polysilicon were prepared. The wafers blanketed with tungsten were prepared by forming a thermal oxide layer having a thickness of about 1000 Å on a bare silicon wafer and then forming a tungsten layer having a thickness of about 500 Å on the thermal oxide layer. The wafers blanketed with polysilicon were prepared by forming a thermal oxide layer having a thickness of about 1000 Å on a bare silicon wafer and then forming a polysilicon layer having a thickness of about 850 Å on the thermal oxide layer. Each of the tungsten blanketed wafers and the polysilicon blanketed wafers was treated with the cleaning solutions 1, 2 and 3 for about 10 minutes at a temperature of about 65° C. The results of experiment 1 are summarized in table 1 below.

TABLE 1

| | Cleaning | Cleaning | Cleaning |
|---|---|---|---|
| | solution 1 | solution 2 | solution 3 |
| 3% Ammonia solution | 20 ml | 20 ml | 20 ml |
| 2-Mercaptoethanol | — | 0.2 g | — |
| 2-Butyne 1,4-diol | — | — | 0.2 g |
| Deionized water | 200 ml | 200 ml | 200 ml |
| Uniformity of tungsten | Non-uniform | Substantially | Substantially |
| | | uniform | uniform |
| Etched amount of | 93˜850 | 480˜850 | 168˜224 |
| polysilicon(Å) | | | |
| Uniformity of polysilicon | Non-uniform | Non-uniform | Substantially |
| | | | uniform |

Referring to table 1, the tungsten and polysilicon cleaned with the cleaning solution 1 without a corrosion inhibitor resulted in the tungsten and polysilicon layers having non-uniformity. When cleaning the wafers using cleaning solution 2 having the conventional corrosion inhibitor, the tungsten layer was not corroded and was substantially uniform, but a substantial amount of the polysilicon layer was etched. When cleaning solution 3 having the corrosion inhibitor according to the embodiments of the present invention was used, the polysilicon and the tungsten layers were substantially uniform and the amount of the polysilicon layer that was etched was significantly reduced.

Thus, cleaning solution 3 including a corrosion inhibitor according to an exemplary embodiment of the present invention effectively cleaned a wafer having either a tungsten or a polysilicon layer while preventing the corrosion of the tungsten layer and significantly reducing the etching of the polysilicon layer.

<Experiment 2: Testing a Cleaning Solution Including a Corrosion Inhibitor Represented by Formula 1 and a Surfactant Represented by Formula 2>

Two identical tungsten blanket wafers and two identical polysilicon blanket wafer were prepared. The tungsten blanket wafer and the polysilicon blanket wafer were prepared using the same methods as discussed above in experiment 1. 220 μl of C₁₂H₂₅O(CH₂CH₂O)_{J}H, which is a surfactant according to an exemplary embodiment of the present invention, was added into the cleaning solution 3 of experiment 1 to prepare a cleaning solution 4. 220 μl of C₁₂H₂₅O(CH₂CH₂O)_{J}H was added into the cleaning solution 2 having the conventional corrosion inhibitor of the experiment 1 to prepare a cleaning solution 5. Each of the tungsten blanket wafers and the polysilicon blanket wafers was treated with cleaning solutions 4 and 5 for about 30 minutes at a temperature of about 65° C. The results of experiment 2 are summarized in table 2 below.

TABLE 2

| | Cleaning solution 4 | Cleaning solution 5 |
|---|---|---|
| 3% Ammonia solution | 20 ml | 20 ml |
| 2-Mercaptoethanol | — | 0.2 g |
| 2-Butyne 1,4-diol | 0.2 g | — |
| Deionized water | 200 ml | 200 ml |
| C₁₂H₂₅O(CH₂CH₂O)_{J}H | 220 μl | 220 μl |
| Uniformity of tungsten | Substantially | Substantially |
| | uniform | uniform |
| Etched amount of | 38 | 75.2 |
| polysilicon(Å) | | |
| Uniformity of polysilicon | Substantially | Substantially |
| | uniform | uniform |

Referring to table 2, when cleaning the wafers using cleaning solutions 4 and 5, the tungsten and polysilicon layers were substantially uniform and a significant reduction in the amount of polysilicon etched was observed. However, the amount of the polysilicon etched using cleaning solution 4 was significantly less than the amount of polysilicon etched using cleaning solution 5.

Thus, a cleaning solution including a corrosion inhibitor of the formula 1 and a surfactant of the formula 2 effectively cleaned a wafer having either a tungsten or a polysilicon layer while preventing the corrosion of the tungsten layer and significantly reducing the etching of the polysilicon layer.

Although the experiments 1 and 2 employed a wafer blanketed with tungsten, it will be apparent to those skilled in the art that the cleaning solution of the present invention can be applied to any metal, e.g., copper, aluminum, titanium, tantalum, iridium, cobalt, any like metals, or nitride of a metal.

Accordingly, the cleaning solution having a corrosion inhibitor according to the embodiments of the present invention is environmentally sound and capable of preventing corrosion of metals and significantly reduces damage to polysilicon on a semiconductor device.

What is claimed is:

1. A cleaning solution comprising deionized water, a surfactant and a corrosion inhibitor comprising triple bond and at least one hydroxyl group.

2. The cleaning solution as claimed in claim 1, wherein the corrosion inhibitor is represented by the following formula:
R₁—R₂—C═C—R₃—R₄
wherein any one of R₁ and R₄ is the hydroxyl group (—OH) and the other is hydrogen (—H), a halogen element (—X) or one functional group selected from the group consisting of alkyl (—R) group, alkoxy (RO—) group, amino (—NH₂) group, nitro (—NO₂) group, mercapto (—SH) group, hydroxyl (—OH) group, aldehyde (—CHO) group and carboxyl (—COOH) group; and
R₂ and R₃ are hydrocarbons having 0 to 10 carbons and straight or branched structure.

3. The cleaning solution as claimed in claim 2, wherein the other of R₁ and R₄ is a hydroxy group (—OH), a methyl group (—CH₃) or a methoxy group (—OCH₃).

4. The cleaning solution as claimed in claim 2, the corrosion inhibitor is about 0.0001 to about 10 wt. % of the cleaning solution.

5. The cleaning solution as claimed in claim 1, the corrosion inhibitor is 2-butyne-1,4-diol.

6. The cleaning solution as claimed in claim 1, wherein the surfactant is represented by the following formula:
R₅—(CH₂)_{K}-A
wherein R₅ is methyl group;
K is an integer ranging from 3 to 22; and
A is HO(CH₂CH₂O)_{L}(CH(CH₃)CH₂O)_{M}— or hydroxyl group, wherein L and M are integers ranging from 0 to 15.

7. The cleaning solution as claimed in claim 6, wherein the surfactant is about 0.0001 to about 10 wt. % of the cleaning solution.

8. The cleaning solution as claimed in claim 1, wherein the surfactant is C₁₂H₂₅O(CH₂CH₂O)_{J}H, wherein J is an integer ranging from 5 to 15.

9. The cleaning solution as claimed in claim 1, further comprising an acid solution or an alkaline solution.

10. The cleaning solution as claimed in claim 9, wherein the alkaline solution is selected from the group consisting of sodium hydroxide (NaOH), potassium hydroxide (KOH), ammonium hydroxide (NH₄OH), tetramethyl ammonium hydroxide (N(CH₃)₄OH), chloride solution, or any mixture thereof.

11. The cleaning solution as claimed in claim 9, wherein the alkaline solution is about 0.0001 to about 10 wt. % of the cleaning solution.

12. The cleaning solution as claimed in claim 9, wherein the acid solution is selected from the group consisting of hydrochloric acid (HCl), nitric acid (HNO₃), sulfuric acid (H₂SO₄), phosphoric acid (mP₂O₅.nH₂O), fluoric acid (HF), an organic acid, and any mixture thereof.

13. The cleaning solution as claimed in claim 12, wherein the organic acid is selected from the group consisting of citric acid, tricarballylic acid, tartaric acid, succinic acid, malic acid, aspartic acid, glutaric acid, adipic acid, suberic acid, oxalic acid, acetic acid and fumaric acid.

14. The cleaning solution as claimed in claim 9, wherein the acid solution is about 0.0001 to about 10 wt. % of the cleaning solution.

15. A cleaning solution comprising a corrosion inhibitor represented by the following formula:
R₁—R₂—C≡C—R₃—R₄
wherein any one of R₁ and R₄ is a hydroxyl group (—OH) and the other is hydrogen (—H), a halogen element (—X) or one functional group selected from the group consisting of alkyl (—R) group, alkoxy (RO—) group, amino (—NH₂) group, nitro (—NO₂) group, mercapto (—SH) group, hydroxyl (—OH) group, aldehyde (—CHO) group and carboxyl (—COOH) group; and
R₂ and R₃ are hydrocarbons comprising 0 to 10 carbons having a straight or a branched structure.

16. The cleaning solution as claimed in claim 15, wherein the other of R₁ and R₄ is a hydroxy group (—OH), a methyl group (—CH₃) or a methoxy group (—OCH₃).

17. The cleaning solution as claimed in claim 15, the corrosion inhibitor of the formula 1 is about 0.0001 to about 10 wt. % of the cleaning solution.

18. The cleaning solution as claimed in claim 15, the corrosion inhibitor is 2-butyne-1,4-diol.

19. The cleaning solution as claimed in claim 15, further comprising a surfactant represented by the following formula:
R₅—(CH₂)_{K}-A
wherein R₅ is methyl group;
K is an integer ranging from 3 to 22; and
A is HO(CH₂CH₂O)_{L}(CH(CH₃)CH₂O)_{M}— or hydroxyl group, wherein L and M are integers ranging from 0 to 15.

20. The cleaning solution as claimed in claim 19, wherein the surfactant is about 0.0001 to about 10 wt. % of the cleaning solution.

21. The cleaning solution as claimed in claim 19, wherein the surfactant is C₁₂H₂₅O(CH₂CH₂O)_{J}H, wherein J is an integer ranging from 5 to 15.

22. The cleaning solution as claimed in claim 15, further comprising an acid solution or an alkaline solution.

23. The cleaning solution as claimed in claim 22, wherein the alkaline solution is selected from the group consisting of sodium hydroxide (NaOH), potassium hydroxide (KOH), ammonium hydroxide (NH₄OH), tetramethyl ammonium hydroxide (N(CH₃)₄OH), chloride solution, and any mixtures thereof.

24. The cleaning solution as claimed in claim 22, wherein the alkaline solution is about 0.0001 to about 10 wt. % of the cleaning solution.

25. The cleaning solution as claimed in claim 22, wherein the acid solution is selected from the group consisting of hydrochloric acid (HCl), nitric acid (HNO₃), sulfuric acid (H₂SO₄), phosphoric acid (mP₂O₅.nH₂O), fluoric acid (HF), an organic acid, and any mixture thereof.

26. The cleaning solution as claimed in claim 25, wherein the organic acid is selected from the group consisting of citric acid, tricarballylic acid, tartaric acid, succinic acid, malic acid, aspartic acid, glutaric acid, adipic acid, suberic acid, oxalic acid, acetic acid and fumaric acid.

27. The cleaning solution as claimed in claim 22, wherein the acid solution is about 0.0001 to about 10 wt. % of the cleaning solution.
